(19) United States
(12) Patent Application Publication
(10) Pub. No.: US 2009/0106844 A1
(43) Pub. Date: Apr. 23, 2009

(54) SYSTEM AND METHOD FOR VULNERABILITY ASSESSMENT OF NETWORK BASED ON BUSINESS MODEL

(76) Inventors: Jun Yoon, Hwaseong-si (KR); Won-Tae Sim, Seongnam-si (KR); Woo-Han Kim, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/941,226

(22) Filed: Nov. 16, 2007

(30) Foreign Application Priority Data
Oct. 19, 2007 (KR) 10-2007-0105568

(51) Int. Cl. G06F 11/00

(52) U.S. Cl. 726/25

(57) ABSTRACT

Provided are a system and a method for vulnerability assessment of a network based on a business model. In the system and method, services of each node existing in a monitoring target network are monitored, and a business model is generated on the basis of the monitored services so as to perform vulnerability assessment on the business model. Accordingly, it is possible to guarantee the safety and availability of the system and the network while the vulnerability assessment is performed.

### BACKGROUND OF THE INVENTION

1. Field of the Invention

The present invention relates to a system and a method for vulnerability assessment of a network based on a business model. In the system and method, services of each node existing in a monitoring target network are monitored, and a business model is generated on the basis of the monitored services so as to perform vulnerability assessment on the business model. Accordingly, it is possible to guarantee the safety and availability of the system and the network while the vulnerability assessment is performed.

2. Description of the Prior Art

Recently, dependence on telecommunication of national institutions as well as of personal economic activities such as online shopping, Internet banking, and so on is increasing. Accordingly, telecommunication networks need to be protected from hacking and viruses and need to be safely operated.

To protect the telecommunication networks from hacking and viruses, it is preferable that problems are checked through vulnerability analysis on the networks and measures against the problems are set up to prevent damage.

The network vulnerability analysis is divided into a manual assessment method by a security specialist and an assessment method using an automated vulnerability assessment tool. In the manual assessment method, a security specialist personally performs vulnerability assessment using a checklist. The manual assessment method is known as an accurate and stable vulnerability analysis method. However, the manual assessment method is a time consuming method. Therefore, the method can be applied only to a small-sized company having a small number of servers or only to main servers, which require stability, among a large number of servers. Accordingly, in case of a complex and large-scale network, automated vulnerability assessment tools are still used to perform vulnerability analysis.

However, when the vulnerability analysis is performed using the automated vulnerability assessment tools, the following risks may occur.

In general, network vulnerability assessment tools transmit assessment packets and analyze the response packets corresponding to the assessment packets, thereby determining whether a vulnerability is present or not. However, in case of some aggressive vulnerability assessment methods, transmitted assessment packets may destabilize a service or system related to an assessment list. At the worst case, the system may be shut down.

Further, when the number of assessment targets is large and the assessment region is wide, a large quantity of assessment packets required for the assessment may occupy the network such that the availability of the network is infringed. Thus, while the vulnerability assessment is performed, the entire network becomes so unstable that communication-based businesses and services may be delayed for a considerable amount of time.

To solve such a problem, a few techniques are proposed. Some assessment tool developing companies provide methods which can perform assessment through a safe check option, while excluding the assessment methods which may cause the above-described risks. However, it is impossible to perfectly discriminate the assessment methods, which may cause risks, in advance. Therefore, those methods do not perfectly guarantee a safe assessment.

### SUMMARY OF THE INVENTION

An advantage of the present invention is that it provides a system and a method for vulnerability assessment of a network based on a business model, in which services of each node existing in a monitoring target network are monitored, and a business model is generated on the basis of the monitored services so as to perform vulnerability assessment on the business model. Accordingly, it is possible to guarantee the safety and availability of the system and the network while the vulnerability assessment is performed.

According to an aspect of the invention, a system for vulnerability assessment of a network includes one or more nodes existing in a network which is a target of vulnerability assessment, each node providing one or more services, storing a configuration file and a directory of each service, and having a service monitoring agent which monitors whether the configuration file and the directory are changed or not and whether a new service is installed or not; a service integration manager that monitors a state change of each node through the service monitoring agent, decides whether the node is a monitoring target or not and whether or not to permit the state change when the state change is detected, notifies the decision result to the node, and delivers the change information to a business model generator; the business model generator that updates a model related to the node, in which the state change is detected, in accordance with the change information received from the service integration manager, and requests a vulnerability assessment manager to perform vulnerability assessment on the updated model; and the vulnerability assessment manager that has a vulnerability database (DB), performs vulnerability assessment on the model requested from the business model generator, and stores the vulnerability assessment result into the vulnerability DB.

According to another aspect of the invention, a method for vulnerability assessment of a network includes the steps of: (a) at a service monitoring agent, monitoring a configuration file and a directory related to a monitoring target service of each node; (b) at the service monitoring agent, when a change in the configuration file or the directory is detected, delivering the changed object and the location information of the changed object to a service decision module; (c) at the service decision module, deciding whether the changed object received from the service monitoring agent is included in a monitoring list DB or not; (d) when the changed object is included in the monitoring list DB, updating a model through a business model management module; (e) performing vulnerability assessment on the updated model through a vulnerability assessment management module; and (f) storing the vulnerability assessment result into a vulnerability DB.

According to a further aspect of the invention, a method for vulnerability assessment of a network includes the steps of: (a) at a service monitoring agent, monitoring whether a new service is installed into each node or not; (b) at the service monitoring agent, when an attempt to install a new service into the node is detected, temporarily stopping the installation of new service and requesting a service decision module to permit the installation; (c) at the service decision module, deciding whether or not to permit the installation of new service; (d) at the service decision module, when the new service is an object which is allowed to be installed, notifying permission of the installation to the service monitoring agent; (e) updating a model through a business model management module; (f) performing vulnerability assessment on the updated model through a vulnerability assessment management module; and (g) storing the vulnerability assessment result into a vulnerability DB.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram showing the configuration of a system for vulnerability assessment of a network according to the present invention;

FIG. 2 is a diagram showing the detailed configuration of the system for vulnerability assessment of a network according to the invention;

FIG. 3 is a flow chart showing a process of the system when a configuration file and a directory related to a specific service are changed; and

FIG. 4 is a flow chart showing a process of the system when the installation of new service is detected.

### DETAILED DESCRIPTION OF EXEMPLARY EMBODIMENTS

Hereinafter, embodiments of the present invention will be described with reference to the accompanying drawings. However, the present invention is not limited to the embodiments.

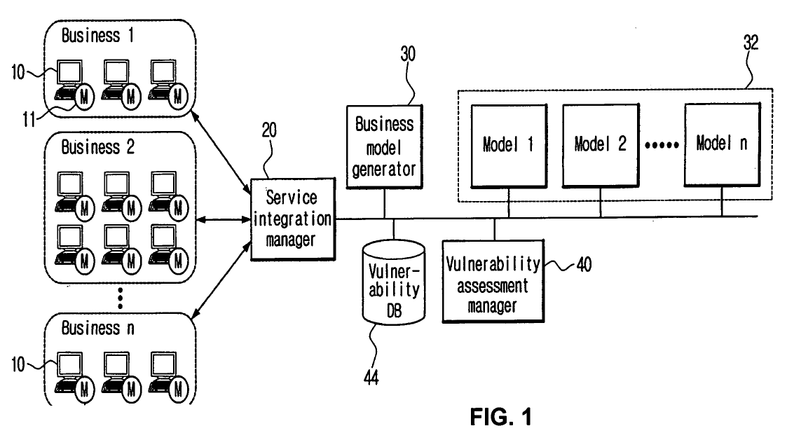

FIG. 1 is a diagram showing the configuration of a system for vulnerability assessment of a network according to the present invention. The system includes a plurality of nodes 10 existing in a network, a service integration manager 20, a business model generator 30, and a vulnerability assessment manager 40.

The plurality of nodes 10 existing in the network, which is a target of vulnerability assessment, are classified depending on provided businesses, regardless of the physical locations thereof. Each of the nodes 10 has a service monitoring agent 11 installed therein, the service monitoring agent 11 serving to monitor services, configuration files, and designated directories of the node 10.

The service integration manager 20 monitors a state change of each node 10 through the service monitoring agent 11 of the node 10 and controls the change. When the state change of the node 10 is detected, the service integration manager 20 determines whether or not the node 10 is a monitoring target and whether or not to permit the change. Then, the service integration manager 20 delivers the change information to the business model generator 30. Meanwhile, when the service integration manager 20 receives vulnerability information from the vulnerability assessment manager 40, the service integration manager 20 generates an alarm, as will be described below.

The business model generator 30 updates a model related to the changed node in accordance with the change information, and requests the vulnerability assessment manager 40 to perform vulnerability assessment.

The vulnerability assessment manager 40 performs vulnerability assessment on the requested model and stores the assessment result into a vulnerability DB 44. When a serious vulnerability with a level higher than a predetermined level is found, the vulnerability assessment manager 40 delivers relevant information to the service integration manager 20.

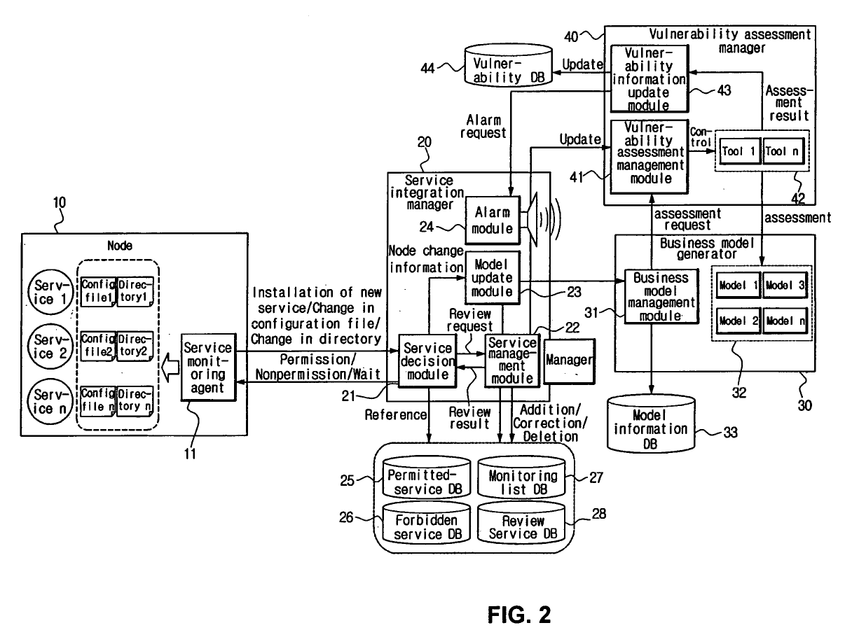

FIG. 2 is a diagram showing the detailed configuration of the system for vulnerability assessment of a network according to the invention. Hereinafter, the interactions among modules composing the system for vulnerability assessment of a network according to the invention will be described in detail with reference to FIG. 2.

Each of the nodes 10 existing in a network, which is a target of vulnerability assessment, executes services required for performing an allocated business. Services required for each business and services forbidden in each business are previously defined by a security manager, and lists thereof are stored in a permitted-service DB 25 and a forbidden-service DB 26, respectively. Further, a list of services, which should be monitored for vulnerability management, and a configuration file and a directory related to the operation of each service are previously defined by the security manager and are then stored in a monitoring list DB 27.

In each of the nodes 10, the service monitoring agent 11 is installed. The service monitoring agent 11 monitors executed services, among services which belong to the service list stored in the monitoring list DB 27, and configuration files and directories related to the executed services. In particular, the service monitoring agent 11 monitors whether a new service is installed or not and whether configuration files and directories are changed or not. When a new service is installed, the service monitoring agent 11 temporarily stops the installation of the service and notifies the installation to a service decision module 21 of the service integration manager 20. Then, the service monitoring agent 11 carries out or stops the installation, depending on the respond from the service decision module 21. When a change in a configuration file or a directory occurs, the service monitoring agent 11 notifies the change to the service decision module 21 of the service integration manager 20. At this time, the service monitoring agent 11 delivers the location and content of the changed entity to the service decision module 21.

The service integration manager 20 includes the service decision module 21, a service management module 22, a model update module 23, and an alarm module 24. Further, the service integration manager 20 includes the permitted-service DB 25, the forbidden-service DB 26, the monitoring list DB 27 and a review service DB 28.

When the service monitoring agent 11 installed in each of the nodes 11 notices the installation or change as described above, the service decision module 21 decides whether or not to permit the installation and/or change, based on the data stored in the permitted-service DB 25, the forbidden-service DB 26, the monitoring list DB 27, and the review service DB 28.

More specifically, when the notice for installation of new service is received, the service decision module 21 decides whether or not to permit the installation of service by referring to the permitted-service DB 25 and the forbidden-service DB 26. When the service requested for the review of permission for installation is stored in the permitted-service DB 25, that is, when the service is permitted in a business of the corresponding node, the installation of the service is allowed. On the contrary, when the service is stored in the forbidden-service DB 26, that is, when the service is forbidden in a business of the corresponding node, the installation of the service is not allowed. Meanwhile, when the service is stored in neither the permitted-service DB 25 nor the forbidden-service DB 26, the service decision module 21 stores the service information into the review service DB 28 and requests the service management module 22 to review the service. Then, when the service management module 22 updates a review result of the service into the DB as will be described below, the service decision module 21 decides whether or not to permit the installation of service based on the review result, as described above. The service decision module 21 delivers the decision result to the service monitoring agent 11.

When the notice for the installation of new service is received and the installation is permitted, or when the notification of the change in the configuration file and/or directory of the node 10 is received, the service decision module 21 delivers the node change information to the model update module 23.

The service management module 22 receives the review request for the new service from the service decision module 22, and then notifies the request to a manager. When the service management module 22 receives from the manager the review result on whether or not to permit the new service, the service management module 22 updates the permitted-service DB 25, the forbidden-service DB 26, and the monitoring list DB 27 and removes the entity corresponding to the service from the review service DB 28. When the review result indicates that the installation of the service is not permitted, the service management module 22 registers the corresponding service into the forbidden-service DB 26. On the contrary, when the review result indicates that the installation of the service is permitted, the service management module 22 registers the corresponding service into the permitted-service DB 25. Further, the service management module 22 registers information on a configuration file and a directory, which is related to the corresponding service, into the monitoring list DB 27.

The model update module 23 receives the node change information from the service decision module 21 so as to make a model change request to the business model management module 31 of the business model generator 30.

When a serious vulnerability is found, the alarm module 24 receives an alarm request from a vulnerability information update module 43 of the vulnerability assessment manager 40. In this case, the alarm module 24 generates an alarm.

The business model generator 31 includes a business model management module 31, a plurality of business models 32, and a model information DB 33.

The business model management module 31 receives model change information from the model update module 23 of the service integration manager 20, updates a corresponding model 32, and stores the update information into the model information DB 33. The respective models 32 are generated by classifying the nodes, existing in a network which is a target of vulnerability assessment, depending on businesses provided by the respective nodes. Like the nodes 10, the models 32 are constructed and operated as independent systems. When the model update is completed, the business model management module 31 makes a request for vulnerability assessment of the updated model to the vulnerability assessment management module 41 of the vulnerability assessment manager 40.

The vulnerability assessment manger 40 includes a vulnerability assessment management module 41, a vulnerability information update module 43, a vulnerability assessment tool 42, and a vulnerability DB 44.

The vulnerability assessment management module 41 receives an assessment request from the business model management module 31 of the business module generator 30 and then executes the vulnerability assessment tool 42.

When the vulnerability assessment tool 42 completes the assessment, the vulnerability information update module 43 collects assessment results and then updates the vulnerability information related to the node, where the change occurs, into the vulnerability DB 44. At this time, vulnerability information for each node is stored into the vulnerability DB 44. Further, when a serious vulnerability is found, the vulnerability information update module 43 requests the service integration manager 20 to generate an alarm.

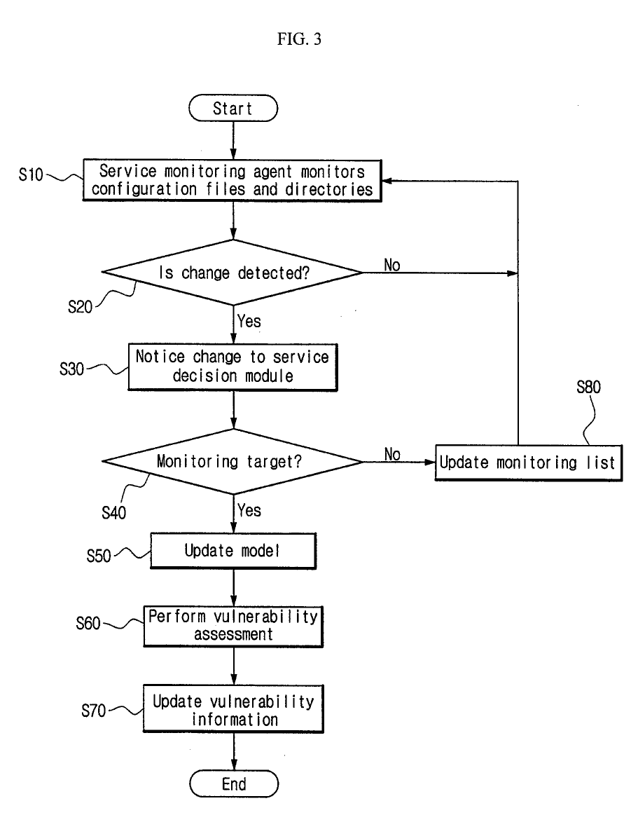

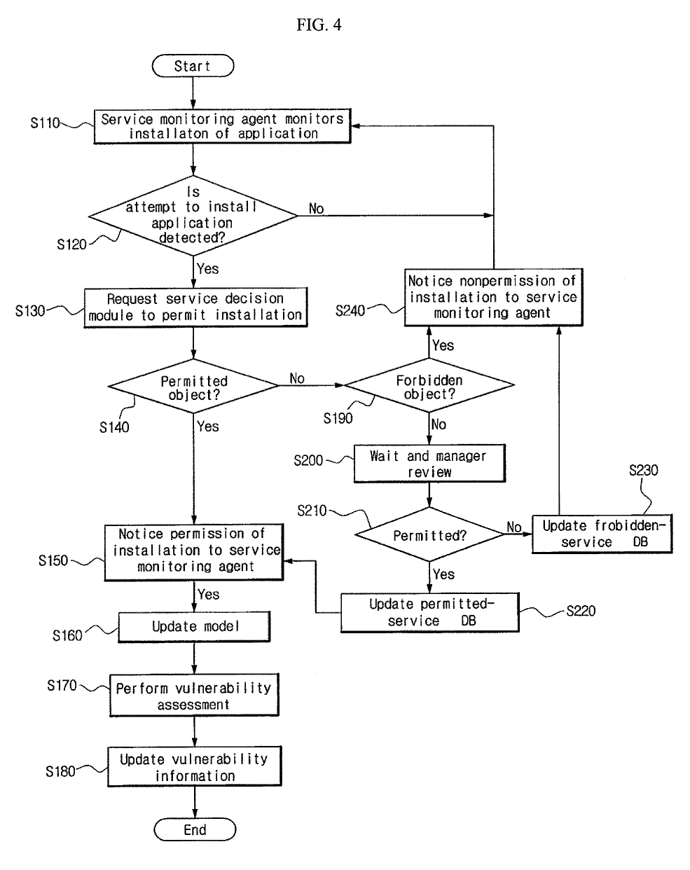

Hereinafter, a method for vulnerability assessment of a network based on a business model will be described with reference to FIGS. 3 and 4.

FIG. 3 is a flow chart showing a process of the system when a configuration file and a directory related to a specific service is changed.

The service monitoring agent 11 receives from the service decision module 21 a service list and a list of configuration files and directories stored in the monitoring list DB 27 which are a monitoring target for each service. The service monitoring agent 11 searches services existing in the corresponding node, which are monitoring targets, and checks the locations of the configuration files and directories related to the service. Then, the service monitoring agent 11 creates a local monitoring list and then starts to monitor the configuration files and directories (step S10). When a change in the monitoring target is detected (step S20), the service monitoring agent 11 makes a notification for the change by delivering the changed object and the location thereof to the service decision module 21 (step S30). The service decision module 21 monitors whether the received changed object is included in the monitoring list or not (step S40). When the changed object is not included in the monitoring list, the service decision module 21 updates the monitoring list of the service monitoring agent 11 (step S80), and resumes monitoring the configuration files and directories (step S10). When the changed object is included in the monitoring list, the business model management module 23 updates a corresponding model (step S50). After that, the vulnerability assessment management module 41 performs vulnerability assessment on the updated model (step S60), and the assessment result is stored in the vulnerability DB 44 (step S70).

FIG. 4 is a flow chart showing a process of the system when the installation of new service is detected.

The service monitoring agent 11 monitors whether a new service is installed in the corresponding node or not (step S110). When the installation of new service is detected (step S120), the service monitoring agent 11 temporarily stops the installation and requests the service decision module 21 to permit the installation of service (step S130). When the new service is an object which is allowed to be installed, the service decision module 21 notifies permission of the installation to the service monitoring agent 11 (step S150), and the business model management module 23 updates a corresponding model (step S160). Further, the vulnerability assessment management module 41 performs vulnerability assessment on the updated model (step S170), and the assessment result is stored in the vulnerability DB 44 (step S180). On the contrary, when the new service is an object which is forbidden to be installed (step S190), the service decision module 21 notifies nonpermission of the installation to the service monitoring agent 11 (step S240), and resumes monitoring whether a new service is installed or not (step S110). Meanwhile, when the new service is neither an object which is allowed to be installed nor an object which is forbidden to be installed, the service decision module 21 notifies a review request to a manager and then enters a wait mode (step S200). When the manager permits the installation, the service decision module 21 registers the corresponding service information into the permitted-service DB 25 (step S220), and notifies permission of the installation to the service monitoring agent 11 (step S150). Then, as described above, the model update (step S160), the vulnerability assessment (step S170), and the vulnerability information update (step S180) are performed sequentially. On the contrary, when the manager does not permit the installation, the service decision module 21 registers the corresponding service information into the forbidden-service DB 26 (step S230), and notifies nonpermission of the installation to the service monitoring agent 11 (step S240). Then, the service monitoring agent 11 resumes monitoring whether a new service is installed or not (step S110).

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

According to the present invention, services existing in nodes on a network are monitored, and business models are generated on the basis of the monitored services. Then, vulnerability assessment is performed on the models. Therefore, it is possible to guarantee the safety and availability of the system and the network, while the vulnerability assessment is performed.

Further, a smaller number of representative models are generated, and the vulnerability assessment is performed only on a model in which a change occurs, among many models. Therefore, time required for the assessment is significantly shortened.

Further, the vulnerability assessment according to the invention is performed immediately after a change occurs, for example, after a new service is installed or a configuration change occurs in each node. Therefore, the occurrence of vulnerability caused by the change in the node is immediately checked, which makes it possible to prevent misuse.

Furthermore, the installation of software, which is unnecessary for each node, is monitored. Therefore, it is possible to prevent the occurrence of vulnerability caused by the installation of service which infringes a security policy of the system.

What is claimed is:

1. A system for vulnerability assessment of a network, the system comprising:
one or more nodes existing in a network which is a target of vulnerability assessment, each node providing one or more services, storing a configuration file and a directory of each service, and having a service monitoring agent which monitors whether the configuration file and directory are changed or not and whether a new service is installed or not;
a service integration manager that monitors a state change of each node through the service monitoring agent, decides whether the node is a monitoring target or not and whether or not to permit the state change when the state change is detected, notifies the decision result to the node, and delivers the change information to a business model generator;
the business model generator that updates a model related to the node, in which the state change is detected, in accordance with the change information received from the service integration manager, and requests a vulnerability assessment manager to perform vulnerability assessment on the updated model; and
the vulnerability assessment manager that has a vulnerability DB, performs vulnerability assessment on the model requested from the business model generator, and stores the vulnerability assessment result into the vulnerability DB.

2. The system according to claim 1, wherein the model is a model obtained by classifying one or more nodes existing in the network, which is a target of vulnerability assessment, depending on businesses provided by the respective nodes.

3. The system according to claim 1, wherein when a serious vulnerability with a level higher than a predetermined level is found, the vulnerability assessment manager delivers the vulnerability information to the service integration manager, and
the service integration manager generates an alarm based on the vulnerability information received from the vulnerability assessment manager.

4. The system according to claim 1, wherein the service integration manager includes:
a permitted-service DB for storing a list of services required for a specific business, which is previously defined by a manager;
a forbidden-service DB for storing a list of services forbidden in a specific business, which is previously defined by the manager; and
a monitoring list DB for storing a service list, which is previously defined by the manager and should be monitored for vulnerability management, and a configuration file and a directory related to operation of each service included in the service list.

5. The system according to claim 4, wherein the service monitoring agent monitors whether or not a new service is installed into each node having the service monitoring agent installed therein and whether or not the configuration file and directory of an executed service are changed, among the services included in the service list stored in the monitoring list DB.

6. The system according to claim 5, wherein when the service monitoring agent detects the installation of new service, the service monitoring agent temporarily stops the installation of new service, notifies the installation of new service to the service integration manager, and carries out or stops the installation of new service, depending on the respond from the service integration manager.

7. The system according to claim 5, wherein when the service monitoring agent detects the change in the configuration file or directory, the service monitoring agent notifies the change to the service integration manager, and delivers the location of a changed entity and the changed content to the service integration manager.

8. The system according to claim 4, wherein the service integration manger includes:
a service decision module which, when the installation of new service or the change in configuration file or directory is notified from the service monitoring agent, decides whether or not to permit the installation or the change based on the data stored in the permitted-service DB, the forbidden-service DB, and the monitoring list DB, delivers the decision result to the service monitoring agent, and when the installation or the change is permitted, delivers the node change information to a model update module;
a service management module which receives a review request for the new service from the service decision module, receives from the manager the review result on whether or not to permit the installation of new service, and updates the permitted-service DB, the forbidden-service DB, and the monitoring list DB depending on the review result;
the model update module which receives the node change information from the service decision module and requests the business model generator to change a corresponding model in accordance with the node change information; and
an alarm module which generates an alarm when vulnerability information is received from the vulnerability assessment manager as a serious vulnerability with a level higher than a predetermined level is found by the vulnerability assessment manager.

9. The system according to claim 1, wherein the business model generator includes:
a model information DB for storing model information;
a business model management module which receives the model change information from the service integration manager, updates the changed model, updates the model information DB on the basis of the model change information, and requests the vulnerability assessment manager to perform vulnerability assessment on the updated model; and
one or more models generated by classifying one or more nodes, existing in the network which is a vulnerability assessment target, depending on businesses provided by the respective nodes.

10. The system according to claim 1, wherein the vulnerability assessment manager includes:
a vulnerability DB for storing vulnerability information on each node existing in the network which is a target of vulnerability assessment;
a vulnerability assessment management module which receives the vulnerability assessment request for the updated model from the business model generator, executes vulnerability assessment tools in accordance with the request, and collects assessment results from the vulnerability assessment tools so as to update vulnerability information on a changed node into the vulnerability DB; and
one or more vulnerability assessment tools which perform vulnerability assessment on the updated model in accordance with the control of the vulnerability assessment management module.

11. A method for vulnerability assessment of a network, the method comprising the steps of:
(a) at a service monitoring agent, monitoring a configuration file and a directory related to a monitoring target service of each node;
(b) at the service monitoring agent, when a change in the configuration file or directory is detected, delivering the changed object and the location information of the changed object to a service decision module;
(c) at the service decision module, deciding whether the changed object received from the service monitoring agent is included in a monitoring list DB or not;
(d) when the changed object is included in the monitoring list DB, updating a model through a business model management module;
(e) performing vulnerability assessment on the updated model through a vulnerability assessment management module; and
(f) storing the vulnerability assessment result into a vulnerability DB.

12. The method according to claim 11, wherein when it is decided at step (c) that the changed object is not included in the monitoring list DB, the service decision module updates a monitoring list of the service monitoring agent.

13. A method for vulnerability assessment of a network, the method comprising the steps of:
(a) at a service monitoring agent, monitoring whether a new service is installed into each node or not;
(b) at the service monitoring agent, when an attempt to install a new service into the node is detected, temporarily stopping the installation of new service and requesting a service decision module to permit the installation;
(c) at the service decision module, deciding whether or not to permit the installation of new service;
(d) at the service decision module, when the new service is an object which is allowed to be installed, notifying permission of the installation to the service monitoring agent;
(e) updating a model through a business model management module;
(f) performing vulnerability assessment on the updated model through a vulnerability assessment management module; and
(g) storing the vulnerability assessment result into a vulnerability DB.

14. The method according to claim 13, wherein when it is decided at step (c) that the new service is an object which is forbidden to be installed, the service decision module notifies nonpermission of the installation to the service monitoring agent.

15. The method according to claim 13, wherein when it is decided at step (c) that the new service is neither an object which is allowed to be installed nor an object which is forbidden to be installed, the service decision module request a manager to review whether or not to permit the installation.

16. The method according to claim 15, wherein when the installation of new service is permitted by the manager, the new service information is updated into a permitted-service DB, and steps (d), (e), (f) and (g) are performed sequentially.

17. The method according to claim 16, wherein when the installation of new service is not permitted by the manager, the new service information is updated into a forbidden-service DB, and the service decision module notifies nonpermission of the installation to the service monitoring agent.
